(19) United States
(12) Patent Application Publication
(10) Pub. No.: US 2006/0061816 A1
(43) Pub. Date: Mar. 23, 2006

(54) Direct printing system

(75) Inventor: Hiroshi Iwatani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/229,705

(22) Filed: Sep. 20, 2005

(30) Foreign Application Priority Data
Sep. 21, 2004 (JP) 2004-273649

(51) Int. Cl. G06F 3/12

(52) U.S. Cl. 358/1.15

(57) ABSTRACT

A direct printing system having a photo-direct printer connected to a digital still camera is provided, in which each of the printer and the camera comprises a decoder and an encoder that are compatible with both commands in PictBridge format and commands in PTP format including VEOC commands specific to each vendor. The VEOC commands include a command for the printer to notify the camera of print layout information which the printer creates, and also include a command for the camera to notify the printer of content of command input from a user about the print layout information. This makes it possible for the user, on the camera side, to identify a print layout at the time of multi-partitioned print in e.g. 4-up layout, and to command change of the print layout according to the PictBridge standard, thereby readily enabling printing according to the intention of the user.

### BACKGROUND OF THE INVENTION

1. Field of the Invention

The present invention relates to a direct printing system in which a digital still image is directly sent from a digital still camera to, and is printed by, a photo-direct printer.

2. Description of the Related Art

Recently, a direct printing system has been widespread in which a digital still image is directly sent from a digital still camera (hereafter referred to as DSC) to, and is printed by, a photo-direct printer (hereafter referred to as PD printer). In the direct printing system, there is a standard called PictBridge, which enables direct printing from a DSC to a PD printer even if the DSC and the PD printer are made by different manufacturers.

This PictBridge enables a multi-partitioned print (layout print), which prints multiple partitioned images on one paper, but does not specify a layout mode for the respective partitioned images in the multi-partitioned print. Accordingly, when a user actually performs a multi-partitioned print in the PictBridge standard, the multi-partitioned print may be done in a print layout different from that the user intends, in some cases, depending on the kind of PD printer. For example, referring to FIG. 7A, even when a user commands printing of partitioned images, intending a multi-partitioned print in the print layout and arrangement order of A, B, C and D as shown in FIG. 7A, the multi-partitioned print may be done in a print layout as shown in FIG. 7B, in some cases, depending on the kind of PD printer.

In many cases, a PD printer may merely lay out respective partitioned images in the order in which the images are selected on a DSC side. Accordingly, unless the user selects the respective partitioned images on the DSC side in the order according to the layout mode of the respective partitioned images on the PD printer side, it is not possible to perform a multi-partitioned print in the intended print layout. For example, when the user wishes to perform a multi-partitioned print in a print layout as shown in FIG. 8, it is necessary for the user to select the respective partitioned images in the order of D, A, C and B on the DSC side.

Furthermore, the conventional multi-partitioned print according to the PictBridge standard has a problem that the layout mode of respective partitioned images is determined by the PD printer, so that the user cannot align the respective partitioned images in an optional orientation. For example, even when the user wishes for the PD printer to perform a multi-partitioned print in a print layout as shown in FIG. 9A, actually the PD printer can only perform a multi-partitioned print in a layout as shown in FIG. 9B.

Japanese Laid-open Patent Publication 2004-62274 discloses a direct printing system in which a PD printer determines a print layout based on image information received from a DSC, and sends a parameter according to the print layout to the DSC in advance of printing the image, so that the DSC displays, on its liquid crystal monitor, a print layout view created on the basis of the parameter received from the PD printer. According to this direct printing system, it is possible for the user on the DSC side to command whether to print the image or not using the print layout, as is, which is then displayed on the liquid crystal monitor of the DSC, and also possible to finely adjust the position of the image, or change the orientation of the image, on the print layout then displayed on the liquid crystal monitor of the DSC.

However, according to the technology of Japanese Laid-open Patent Publication 2004-62274, it is not possible, at the time of the partitioned print, for the user on the DSC side to change the orientation and the arrangement order of the respective partitioned images. Furthermore, commands in PictBridge format and commands in PTP (Picture Transfer Protocol), which are usable in the PictBridge standard, do not include a command for the PD printer to notify the DSC of a print layout of the respective partitioned images, or a command for the DSC to command the PD printer to change or determine a print layout of the respective partitioned images. Accordingly, it is not easy, even if attempted, to apply the technology disclosed in Japanese Laid-open Patent Publication 2004-62274 to a partitioned print according to the PictBridge standard so as to allow the user on the DSC side to command the change or determination of the print layout of the respective partitioned images.

### SUMMARY OF THE INVENTION

An object of the present invention is to provide a direct printing system that enables a user to identify a print layout on DSC side at the time of multi-partitioned print, and that allows the user on the DSC side to command a change of the print layout, thereby making it possible to readily obtain a result of printing according to the intention of the user.

According to a first aspect of the present invention, we provide a direct printing system comprising a digital still camera and a photo-direct printer connected to the digital still camera in which a digital still image is directly sent from the digital still camera to, and is printed by, the photo-direct printer, wherein each of the digital still camera and the photo-direct printer comprises a decoder and an encoder that are compatible with both commands in PictBridge format and commands in PTP format including VEOC (Vendor-Extended Operation Code) commands specific to each vendor.

The VEOC commands include a command for the photo-direct printer to notify the digital still camera of print layout information which the photo-direct printer creates, and also include a command for the digital still camera to notify the photo-direct printer of content of command input from a user about print layout information.

The direct printing system according to the first aspect of the present invention makes it possible for the user to identify, on the side of the digital still camera, a print layout at the time of multi-partitioned print, and for the user to command change of the print layout according to the PictBridge standard on the side of the digital still camera, thereby readily enabling printing according to the intention of the user, although the commands in PictBridge format and the commands in PTP format which can be used in the PictBridge standard do not include either a command for the photo-direct printer to notify the digital still camera of a print layout of partitioned images, or a command for the digital still camera to command the photo-direct printer to change or decide the print layout of the respective partitioned images.

Preferably, the digital still camera further comprises a display means for displaying print layout information received from the photo-direct printer.

Further, the direct printing system can be designed so that the content of command input from the user is to change an arrangement order of multiple partitioned images for printing of the partitioned images on one paper.

Still further, the direct printing system can be designed so that the content of command input from the user is to change an arrangement order and orientation of multiple partitioned images for printing of the partitioned images on one paper.

Furthermore, the direct printing system can be designed so that the content of command input from the user is to change orientation of multiple partitioned images for printing of the partitioned images on one paper.

According to a second aspect of the present invention, we provide a direct printing system comprising a digital still camera and a photo-direct printer connected to the digital still camera in which a digital still image is directly sent from the digital still camera to, and is printed by, the photo-direct printer.

The digital still camera comprises: a camera-side transmission means for sending photographed digital still images to the photo-direct printer, and further for sending and receiving various commands to and from the photo-direct printer, and still further for receiving print layout information from the photo-direct printer; a display means for displaying the print layout information received by the camera-side transmission means from the photo-direct printer; a command input means for inputting a command to send the photographed digital still images to the photo-direct printer, and further for inputting a command to print multiple partitioned images on one paper, and still further for inputting a command to change an arrangement order and/or orientation of the partitioned images; and a camera-side control means for controlling a process in the digital still camera when directly sending digital still images to the photo-direct printer for printing,

The photo-direct printer comprises: a printer-side transmission means for receiving the digital still images sent from the digital still camera, and further for sending and receiving the various commands to and from the digital still camera, and still further for sending the print layout information to the digital still camera; a printer-side control means for controlling the printer-side transmission means to receive the digital still images sent from the digital still camera so as to create print layout information based on the thus received digital still images, and further for controlling the printer-side transmission means to send the thus created print layout information to the digital still camera; and a layout changing means for changing an arrangement order and/or orientation of multiple partitioned images when a user, using the command input means, inputs command to change the arrangement order and/or the orientation of the partitioned images.

Each of the camera-side control means and the printer-side control means comprises a decoder and an encoder that are compatible with both commands in PictBridge format and commands in PTP format including VEOC (Vendor-Extended Operation Code) commands specific to each vendor. Using a code contained in the VEOC and also using the encoder of the photo-direct printer, the printer-side control means creates a command for notifying the digital still camera of the print layout information created by the photo-direct printer, and controls the printer-side transmission means to send the thus created command to the digital still camera.

When the user, using the command input means, inputs command to change the arrangement order and/or the orientation of the partitioned images in the print layout information, or when the user, using the command input means, inputs command for performing printing, using the print layout information, as is, then displayed on the display means, the camera-side control means uses a code contained in the VEOC and also uses the encoder of the digital still camera in order to create a command for notifying the photo-direct printer of content of the thus input command, and further controls the camera-side transmission means to send the thus created command to the photo-direct printer.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic view of a PD printer and a DSC that constitute a direct printing system according to an embodiment of the present invention;

FIG. 2 is an electrical block diagram of the PD printer and the DSC;

FIG. 3 is a communication protocol architecture of PictBridge employed in the direct print system;

FIG. 4 is a chart showing a protocol of a process of identifying and changing a print layout in the direct printing system;

FIG. 5 is a chart for explaining a process of changing an orientation of partitioned images in the process of identifying and changing the print layout;

FIG. 6 is a chart for explaining a process of changing an arrangement order and orientation of partitioned images in the process of identifying and changing the print layout; and

Each of FIG. 7A, FIG. 7B, FIG. 8, FIG. 9A and FIG. 9B is a chart for explaining a problem in a conventional direct printing system at the time of multi-partitioned print.

### DESCRIPTION OF THE PREFERRED EMBODIMENTS

The best modes and preferred embodiments of the present invention will be described hereinafter with reference to the annexed drawings. The present invention relates to a direct printing system in which a digital still image is directly sent from a digital still camera (hereafter referred to as DSC) to, and is printed by, a photo-direct printer (hereafter referred to as PD printer). Note that the specific embodiments described are not intended to cover the entire scope of the present invention, and hence the present invention is not limited to only the specific embodiments.

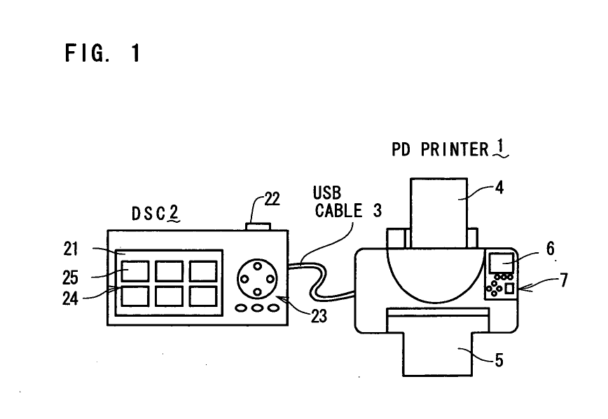

FIG. 1 shows a schematic view of a PD printer 1 and a DSC 2 that constitute a direct printing system according to an embodiment of the present invention. This direct print system uses PictBridge technology to achieve direct printing from the DSC 2 to the PD printer 1. The PD printer 1 and the DSC 2 are connected to each other via a USB (Universal Serial Bus) cable 3. Here, PictBridge technology is an industry standard established by the Camera & Imaging Products Association (CIPA), an organization in Japan, which enables digital images to be printed from a digital camera without using a personal computer, or which enables direct printing from a DSC to a PD printer even if the DSC and the PD printer are made by different manufacturers.

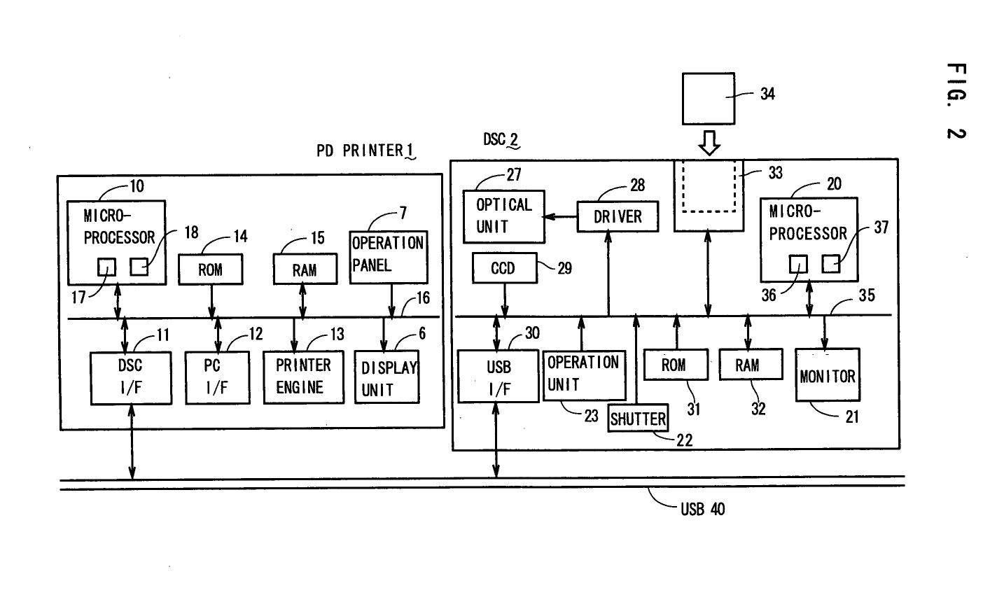

As shown in FIG. 1, the PD printer 1 comprises: a feed tray 4 for loading photo-printing papers; a discharge tray 5 for loading printed papers; a liquid crystal display unit 6 for displaying various messages and so on; and an operation panel 7 for performing various operations. On the other hand, as shown in FIG. 1, the DSC 2 comprises: a liquid crystal monitor 21 (display means) and an operation unit 23 (command input means) for performing various operations, which are provided on the rear side of the DSC 2; and a shutter 22 provided on an upper end of the DSC 2. Displayed on the liquid crystal monitor 21 are: an image of light which is then incident on a CCD (Charge-Coupled Device) 29 (refer to FIG. 2); a photographed digital still image or images 25 (hereafter referred to as photographed image or images); a selection screen 24 for selecting images to be printed in a multi-partitioned print, that is printing of multiple partitioned images on one paper; and print layout information received from the PD printer 1. As shown in FIG. 1, the selection screen 24 is a screen displaying a group of multiple photographed images 25 in thumbnail size.

FIG. 2 shows an electrical block diagram of the PD printer 1 and the DSC 2. The PD printer 1 comprises, in addition to the liquid crystal display unit 6 and the operation panel 7: a microprocessor 10 (serving as a printer-side control means) for controlling the entire PD printer 1; a DSC I/F 11 (serving as a printer-side transmission means) which is an interface circuit for connection to the DSC 2 (namely an interface circuit on the host side of the USB); a PC (Personal Computer) I/F 12 which is an interface circuit for connection to a personal computer; a printer engine 13 for printing images received from e.g. the DSC 2; a ROM (Read-Only Memory) 14 for storing font data and a control program describing a procedure of the microprocessor 10; and a RAM (Random Access Memory) 15 for temporarily storing images received from e.g. the DSC 2 and later described print layout information.

In the present specification, the term “transmission” and “transmit” is used to mean “sending and receiving” and “send and receive”. Transmission of data among these units or elements in the PD printer 1 is done via an internal bus 16 as shown in FIG. 2. The DSC I/F 11 receives digital still images sent from the DSC 2, and further send and receive various commands to and from the DSC 2, and still further send to the DSC 2 the print layout information which will be described in detail later. The microprocessor 10 comprises a decoder 17 and an encoder 18 that are able to handle (i.e. are compatible with) both commands in PictBridge format and commands in PTP (Picture Transfer Protocol) format including VEOC (Vendor-Extended Operation Code) commands specific to each vendor. Further, the microprocessor 10 also serves as a claimed layout changing means which will be described in detail later.

On the other hand, the DSC 2 comprises, in addition to the liquid crystal monitor 21 (monitor), the shutter 22 and the operation unit 23: a microprocessor 20 (camera-side control means) for controlling the entire DSC 2; an optical unit 27 comprising a lens and its drive system; a driver 28 for controlling the optical unit 27; a CCD (Charge Coupled Device) 29 which is an imaging device; a USB I/F 30 (camera-side transmission means) which is an interface circuit for connection to the PD printer 1 (namely an interface circuit on the slave side of the USB); a ROM 31 for storing a control program describing a procedure of the microprocessor 20; a RAM 32 for temporarily storing various data such as later described print layout information; and a connector 33 for connection to a memory card 34 for recording photographed images. Transmission of data among these units or elements in the DSC 2 is done via an internal bus 35 as shown in FIG. 2. The microprocessor 20 comprises a decoder 36 and an encoder 37 that are able to handle (i.e. are compatible with) commands in PictBridge format and commands in PTP format including VEOC (Vendor-Extended Operation Code) commands specific to each vendor.

Transmission of data between the DSC 2 and the PD printer 1 is done via the USB I/F 30, a USB 40 and the DSC I/F 11.

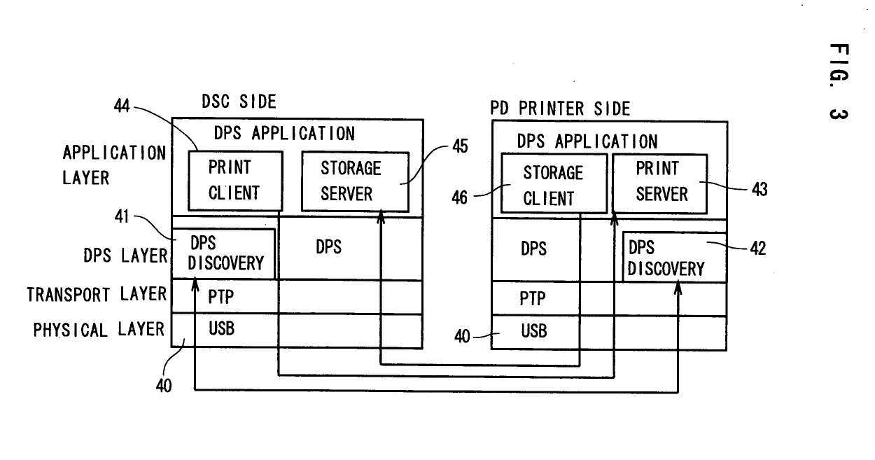

FIG. 3 shows a communication protocol architecture of PictBridge employed in the direct printing system. In PictBridge, USB (here USB 40) is used as a physical layer, and PTP is used as a transport layer on the physical layer (USB). Further, as shown in FIG. 3, a DPS (Digital Photo Solution) layer, which is an additional conversion layer, is provided between the transport layer and an application layer. This DPS layer provides a mapping between the communication protocol of PTP and DPS applications in the application layer. PictBridge is a technology that standardizes the interface protocol between the DPS layer and the application layer.

Next, referring to FIG. 3, software components of PictBridge will be described. The software components of PictBridge include Print Server 43, Print Client 44, Storage Server 45 and Storage Client 46 existing in the application layer, and further include DPS Discoveries 41 and 42 existing in the DPS layer. In PictBridge, it is assumed that the printer requests the DSC for image data when the printer performs printing in response to a print request from the DSC. Thus, normally, a user does not pay attention to the Storage Client 46. Basically, in the DPS applications in the application layer, each DPS Operation is completed in a sequence that the Server responds to a request from the Client, and then replies with a result of the request back to the Client. Further, each DPS Event is completed in a sequence that the Client responds to a notification issued from the Server, and then replies with a confirmation of the receipt back to the Server.

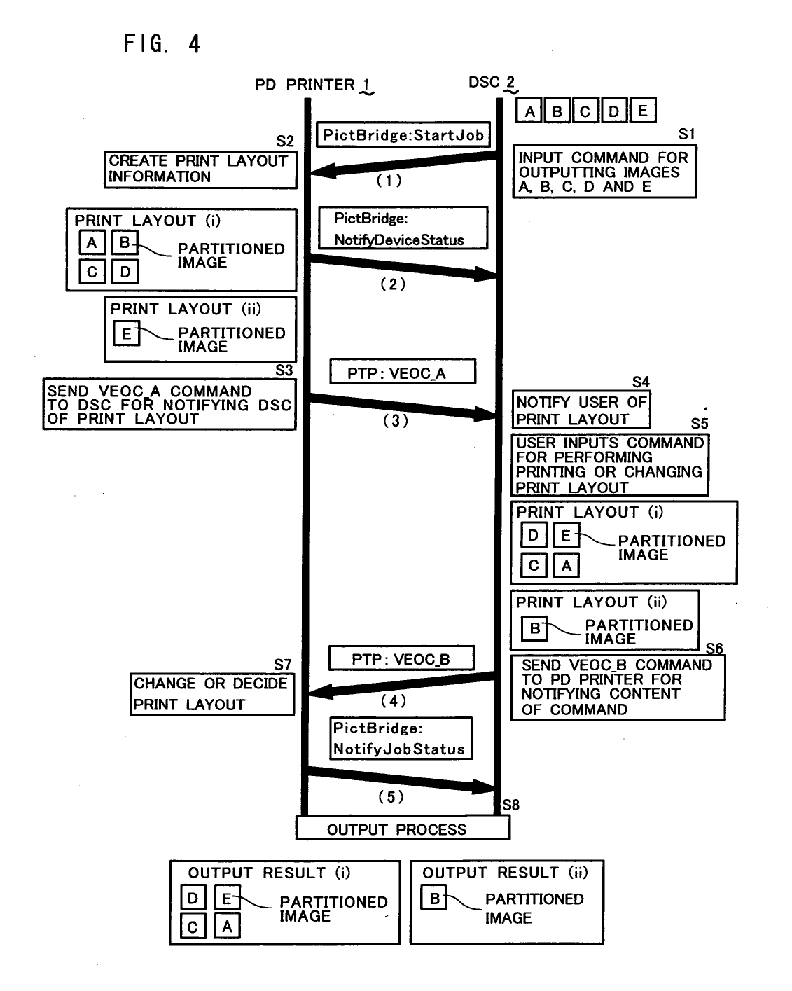

Next, referring to FIG. 4 which is a chart showing a protocol of a process of identifying and changing a print layout in the direct printing system, the function of identifying and changing the print layout in the direct printing system will be described. First, the microprocessor 10 of the PD printer 1, as a device, and the microprocessor 20 of the DSC 2, as a further device, identify information about each other device (product information or device information), and thereafter activate the function of identifying and changing the print layout. More specifically, when the transport layer connection (PTP level connection) between the PD printer 1 and the DSC 2 is established with these devices being connected by the USB cable 3, the microprocessors 10 and 20 perform a negotiation process, using the DPS Discoveries 41 and 42 shown in FIG. 3, to identify whether or not the each other device has a DPS function. If the microprocessors 10 and 20 recognize that the each other device is PictBridge-compatible, and that the each other device has a DPS function, the microprocessors 10 and 20 determine, based on the product information or device information of both the PD printer 1 and the DSC 2, whether both the PD printer 1 and the DSC 2 have a decoder and an encoder that are able to handle (i.e. are compatible with) later described VEOC_A and VEOC_B commands. If the microprocessors 10 and 20 determine that both the PD printer 1 and the DSC 2 have a decoder and an encoder compatible with these commands, the microprocessors 10 and 20 activate the above described function of identifying and changing the print layout.

When a user uses or operates the operation unit 23 in the DSC 2 to input command for multi-partitioned print in 4-up layout (that is a layout for printing four partitioned images on one paper), the microprocessor 20 of the DSC 2 displays a selection screen 24 containing multiple photographed images 25 on the liquid crystal monitor 21 as shown in FIG. 1. In this state, if the user uses or operates the operation unit 23 to select images A, B, C, D and E for multi-partitioned print (hereafter referred to simply as partitioned images) from the photographed images 25 displayed on the selection screen 24 and to input command for outputting these partitioned images (S1), the microprocessor 20 of the DSC 2 using the encoder 37 of the DSC 2 creates a command (StartJob) in PictBridge format for the multi-partitioned print in the 4-up layout. As shown by arrow (1) in FIG. 4, the microprocessor 20 sends the thus created command to the PD printer 1 using the USB I/F 30, and further sends the partitioned images A, B, C, D and E to the PD printer 1 in the order selected by the user using the operation unit 23.

When the microprocessor 10 of the PD printer 1 receives, from the DSC 2, the command in PictBridge format for the multi-partitioned print, the microprocessor 10 decodes the received command using the decoder 17 of the PD printer 1. Then, the microprocessor 10 using the encoder 18 creates a command (NotifyDeviceStatus) in PictBridge format for notifying that the PD printer 1 is in the print state. As shown by arrow (2) in FIG. 4, the microprocessor 10 sends the thus created command to the DSC 2 using the DSC I/F 11. Subsequently, the microprocessor 10 of the PD printer 1 creates print layout information (i) and (ii) (print layout (i) and (ii)) in which the partitioned images A, B, C, D and E received from the DSC 2 are arranged in the received order (S2). Further, using the encoder 18, the microprocessor 10 creates a command (VEOC_A command) in PTP format for notifying the DSC 2 of the thus created print layout information (i) and (ii), and sends this VEOC_A command to the DSC 2 as shown by arrow (3) in FIG. 4 (S3). The VEOC_A command is contained in the VEOC commands. Putting this in another way, the VEOC commands include a command (the VEOC_A command) for the PD printer 1 to notify the DSC 2 of print layout information which the PD printer 1 creats.

When the microprocessor 20 of the DSC 2 receives the VEOC_A command from the PD printer 1, the microprocessor 20 controls the decoder 36 to decode the thus received command, and displays print layout information (i) and (ii) contained in the received command on the liquid crystal monitor 21 and thereby notifies the user of the print layout information (i) and (ii) (S4). When the user uses or operates the operation unit 23: to input command for performing printing, using the print layout information (i) and (ii), as is, that are then displayed on the liquid crystal monitor 21; or to input command for changing the arrangement order and/or orientation of partitioned images A, B, C, D and E in the print layout information (i) and (ii) that are then displayed on the liquid crystal monitor 21 (S5), the microprocessor 20 uses the encoder 37 to create a command (VEOC_B command) in PTP format for notifying the PD printer 1 of the content of the either command (print command or change command), and sends this VEOC_B command to the PD printer 1 (S6). The VEOC_B command is contained in the VEOC commands. Putting this in another way, the VEOC commands include a command for the DSC 2 to notify the PD printer 1 of content of command input from a user about print layout information.

When the microprocessor 10 of the PD printer 1 receives the VEOC_B command, it controls the decoder 17 to decode the thus received command. If the content of the command contained in the received command is to change the arrangement order and/or orientation of partitioned images A, B, C, D and E, the microprocessor 10 changes the print layout information (i) and (ii) according to the content of the command. Thus, the microprocessor 10 also serves as a layout changing means for changing the print layout information (i) and (ii) according to the content of the command to change the print layout information (i) and (ii) when the command is input from a user using the operation unit 23 (command input means) of the DSC 2. On the other hand, if the content of the command contained in the received command is to perform printing, using the print layout information (i) and (ii) as is, the microprocessor 10 uses, as decided print layout information, the print layout information (i) and (ii), as is, that are created in the above step S2 (S7).

Further, based on the print layout information (i) and (ii) that have been changed or decided in the step S7, the microprocessor 10 starts an output process of multi-partitioned print (S8). Each time an event such as “printing on n-th paper completed” or “printing ended” occurs, the microprocessor 10 creates, using the encoder 18, a command (NotifyJobStatus) in PictBridge format for indicating a print job state, and sends the thus created command to the DSC 2 as shown by arrow (5) in FIG. 4.

For example, when the user uses or operates the operation unit 23 of the DSC 2 to input command for changing the arrangement order of partitioned images A, B, C, D and E in the print layout information (i) and (ii), that are then displayed on the liquid crystal monitor 21, to an arrangement order of partitioned images D, E, C, A and B as shown in FIG. 4, the microprocessor 10 of the PD printer 1 changes the print layout information (i) and (ii) on the side of the PD printer 1 according to the content of this command. Thus, as shown in FIG. 4, the print layout information (i) and (ii) as an output result obtained by the output process in the above step S8 are in accordance with the changed print layout information (i) and (ii).

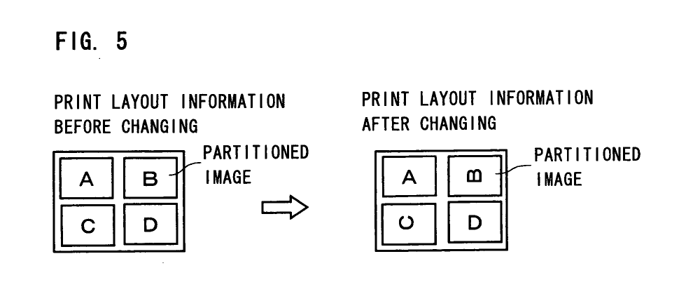

Further, for example, when the user uses or operates the operation unit 23 of the DSC 2 to input command for changing the orientation of certain ones of partitioned images A, B, C and D in the print layout information to an orientation such as shown in FIG. 5, the print layout information on the side of the PD printer 1 is changed according to the content of such command. Thus, the output result obtained by the output process in the above step S8 is in accordance with the changed print layout information.

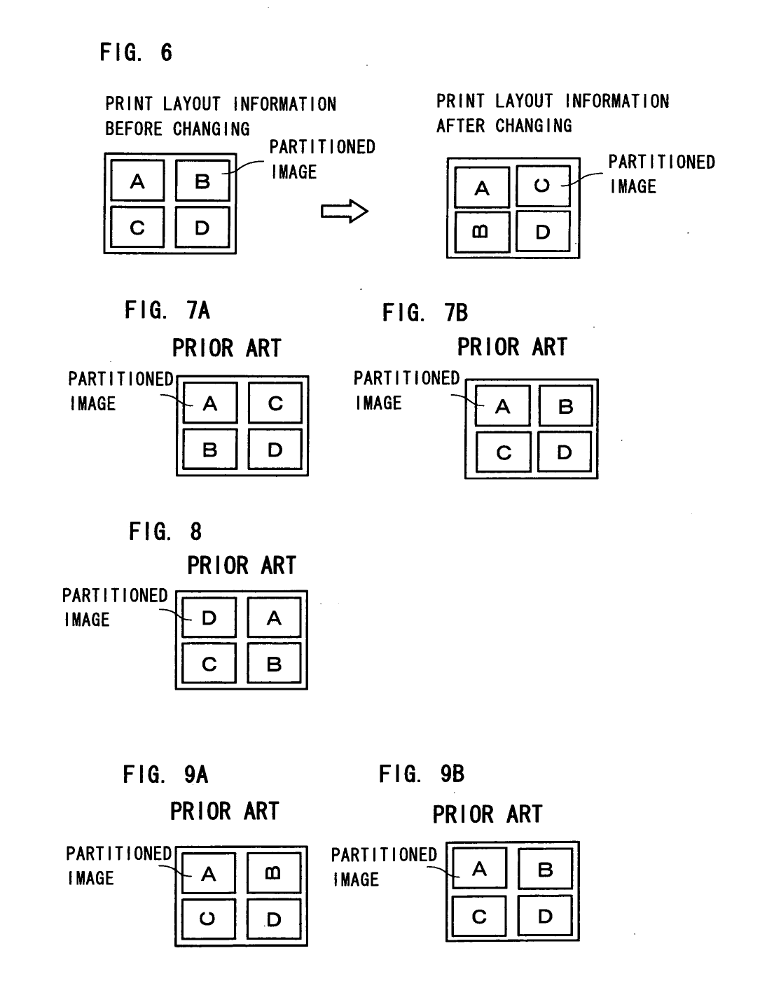

Furthermore, for example, when the user uses or operates the operation unit 23 of the DSC 2 to input command for changing the arrangement order and orientation of certain ones of partitioned images A, B, C and D in the print layout information to those such as shown in FIG. 6, the print layout information on the side of the PD printer 1 is changed according to the content of such command. Thus, the output result obtained by the output process in the above step S8 is in accordance with the changed print layout information.

As described in the foregoing, the direct printing system according to the embodiment is designed to allow both the PD printer 1 and the DSC 2 to have decoders 17 and 36 and encoders 18 and 37 which are able to handle (i.e. are compatible with) both commands in PictBridge format and commands in PTP format including VEOC commands specific to each vendor. The direct printing system is further designed so that the VEOC commands include a command for the PD printer 1 to notify the DSC 2 of print layout information which the PD printer 1 creates, and also include a command for the DSC 2 to notify the PD printer 1 of content of command input from a user about print layout information. More specifically, the direct printing system is designed to use a command contained in the VEOC commands as a command for notifying the DSC 2 of print layout information created by the PD printer 1 as well as to use a command contained in the VEOC commands as a command for notifying the PD printer 1 of content of command input from a user about the print layout information. This makes it possible for the user to identify, on the side of the DSC 2, a print layout at the time of multi-partitioned print in e.g. 4-up layout, and for the user to command change of the print layout according to the PictBridge standard on the side of the DSC 2, thereby readily enabling printing according to the intention of the user, although the commands in PictBridge format and the commands in PTP format which can be used in the PictBridge standard do not include either a command for the PD printer 1 to notify the DSC 2 of a print layout of respective partitioned images, or a command for the DSC 2 to command the PD printer 1 to change or decide the print layout of the respective partitioned images.

It is to be noted that the present invention is not limited to the above embodiments, and various modifications are possible. For example, although the above embodiment describes an example for multi-partitioned print in 4-up layout, the layout to which the preset invention can be applied is not limited thereto. For example, it can be a 2-up layout or an 8-up layout. Further, although the above embodiment describes an example in which the respective commands are sent in the order from StartJob, NotifyDeviceStatus, VEOC_A, VEOC_B to NotifyJobStatus as shown in FIG. 4, the order of sending these commands is not limited thereto. In addition, the above embodiment describes an example in which photographed images selected from those in the DSC are sent, as is, to the PD printer as partitioned images, wherein the PD printer creates print layout information based on the thus sent photographed images. However, it is also possible that the DSC sends thumbnail images of the photographed images to the PD printer, and that the PD printer creates print layout information based on the thus sent thumbnail images.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-273649 filed Sep. 21, 2004, the contents of which are hereby incorporated by reference.

What is claimed is:

1. A direct printing system comprising a digital still camera and a photo-direct printer connected to the digital still camera in which a digital still image is directly sent from the digital still camera to, and is printed by, the photo-direct printer,
wherein each of the digital still camera and the photo-direct printer comprises a decoder and an encoder that are compatible with both commands in PictBridge format and commands in PTP format including VEOC (Vendor-Extended Operation Code) commands specific to each vendor, and
wherein the VEOC commands include a command for the photo-direct printer to notify the digital still camera of print layout information which the photo-direct printer creates, and also include a command for the digital still camera to notify the photo-direct printer of content of command input from a user about print layout information.

2. The direct printing system according to claim 1,
wherein the digital still camera further comprises a display means for displaying print layout information received from the photo-direct printer.

3. The direct printing system according to claim 2,
wherein the content of command input from the user is to change an arrangement order of multiple partitioned images for printing of the partitioned images on one paper.

4. The direct printing system according to claim 2,
wherein the content of command input from the user is to change an arrangement order and orientation of multiple partitioned images for printing of the partitioned images on one paper.

5. The direct printing system according to claim 2,
wherein the content of command input from the user is to change orientation of multiple partitioned images for printing of the partitioned images on one paper.

6. The direct printing system according to claim 1,
wherein the content of command input from the user is to change an arrangement order of multiple partitioned images for printing of the partitioned images on one paper.

7. The direct printing system according to claim 1,
wherein the content of command input from the user is to change an arrangement order and orientation of multiple partitioned images for printing of the partitioned images on one paper.

8. The direct printing system according to claim 1,
wherein the content of command input from the user is to change orientation of multiple partitioned images for printing of the partitioned images on one paper.

9. A direct printing system comprising a digital still camera and a photo-direct printer connected to the digital still camera in which a digital still image is directly sent from the digital still camera to, and is printed by, the photo-direct printer,
wherein the digital still camera comprises:
a camera-side transmission means for sending photographed digital still images to the photo-direct printer, and further for sending and receiving various commands to and from the photo-direct printer, and still further for receiving print layout information from the photo-direct printer;
a display means for displaying the print layout information received by the camera-side transmission means from the photo-direct printer;
a command input means for inputting a command to send the photographed digital still images to the photo-direct printer, and further for inputting a command to print multiple partitioned images on one paper, and still further for inputting a command to change an arrangement order and/or orientation of the partitioned images; and
a camera-side control means for controlling a process in the digital still camera when directly sending digital still images to the photo-direct printer for printing,
wherein the photo-direct printer comprises:
a printer-side transmission means for receiving the digital still images sent from the digital still camera, and further for sending and receiving the various commands to and from the digital still camera, and still further for sending the print layout information to the digital still camera;
a printer-side control means for controlling the printer-side transmission means to receive the digital still images sent from the digital still camera so as to create print layout information based on the thus received digital still images, and further for controlling the printer-side transmission means to send the thus created print layout information to the digital still camera; and
a layout changing means for changing an arrangement order and/or orientation of multiple partitioned images when a user, using the command input means, inputs command to change the arrangement order and/or the orientation of the partitioned images,
wherein each of the camera-side control means and the printer-side control means comprises a decoder and an encoder that are compatible with both commands in PictBridge format and commands in PTP format including VEOC (Vendor-Extended Operation Code) commands specific to each vendor,
wherein using a code contained in the VEOC and also using the encoder of the photo-direct printer, the printer-side control means creates a command for notifying the digital still camera of the print layout information created by the photo-direct printer, and controls the printer-side transmission means to send the thus created command to the digital still camera, and
wherein when the user, using the command input means, inputs command to change the arrangement order and/or the orientation of the partitioned images in the print layout information, or when the user, using the command input means, inputs command for performing printing, using the print layout information, as is, then displayed on the display means, the camera-side control means uses a code contained in the VEOC and also uses the encoder of the digital still camera in order to create a command for notifying the photo-direct printer of content of the thus input command, and further controls the camera-side transmission means to send the thus created command to the photo-direct printer.
